(19) United States
(12) Patent Application Publication
(10) Pub. No.: US 2018/0219974 A1
(43) Pub. Date: Aug. 2, 2018

(54) Method and System for Dynamically Provisioning a Personalized Desktop to User in a Remote Site

(71) Applicant: Wipro Limited, Bangalore (IN)

(72) Inventor: Narasimha Sekhar KAKARAPARTHI, Hyderabad (IN)

(73) Assignee: Wipro Limited

(21) Appl. No.: 15/459,815

(22) Filed: Mar. 15, 2017

(30) Foreign Application Priority Data
Jan. 31, 2017 (IN) 201741003645

(51) Int. Cl. H04L 29/08

(52) U.S. Cl. CPC H04L 67/34; H04L 67/10

(57) ABSTRACT

Disclosed herein is a method and a system for dynamically provisioning personalized desktop to user in a remote site. The method comprises identifying presence of user in the remote site. Upon identifying the user in the remote site, contextual data related to the primary desktop of the user are collected and compared with the contextual data of one or more secondary desktops in the remote site. Based on comparison, one of the secondary desktops, having similar contextual data as that of the primary desktop is selected as the personalized desktop to the user. The disclosed method helps in automatically identifying a roaming user on a remote site and automatically provisioning a desktop to the user in the remote site, thereby improving user experience and efficiency of a user in the remote site.

### TECHNICAL FIELD

The present subject matter is related, in general to automated desktop provisioning and more particularly, but not exclusively to a system and method for dynamically provisioning a personalized desktop to a user in a remote site.

### BACKGROUND

In a typical enterprise environment, the employees or users may have to travel to different branches of the enterprise (guest sites or remote sites), which are in different region/geography, either temporarily or permanently for taking up short-term or long-term work assignments. The users may require dedicated desktops at these remote sites to efficiently execute a given work assignment. However, there may be instances where the users encounter difficulty in finding dedicated temporary desktops at the remote sites, which are as similar or as equivalent to the user's own desktop at a primary location which may be the user's base or home office location. The above limitation may be a result of lack of information about the remote locations lack of time synchronization between different branches in different locations of the enterprise, unavailability of effective IT administration at the remote locations and due to difficulty in locating suitable temporary desktops at the remote location to execute the given work assignment.

Additionally, the network connectivity between the remote sites and the home/base location may suffer from poor performance due to network parameters like latency, transmission etc. Also, configuring multiple high-performance desktops across multiple sites is costly and impractical. This situation can make the employees to forcefully work on a temporary desktop that is equipped with limited or inadequate resources. For example, the remote desktops may have limited processing capabilities, they may not comprise user-preferred applications or the remote desktops may yield low-performance with respect to network latency etc. These inadequacies at the remote desktop may result in a very poor performance from the users and may create an uncomfortable environment for the users who must roam across various locations of the office for various work assignments.

The existing systems for provisioning virtual and/or temporary desktops for a roaming user perform monitoring of network, tracking of information via user devices, creating images of applications in the primary desktop and replicating the user profiles on the servers to configure the remote desktops. These systems may avoid the problems that are related to replication of the primary desktop features on to the secondary desktops. However, the difficulty of finding a dedicated/personalized temporary desktop, which is as similar/equivalent to the user's own desktop (primary desktop) is not solved by the existing techniques/systems.

### SUMMARY

Disclosed herein is a method for dynamically provisioning a personalized desktop to a user in a remote site. The method including identifying, by a desktop provisioning system, the user in the remote site based on profile information of the user. The remote site includes one or more secondary desktops. Upon identifying the user in the remote site, the method collects one or more primary contextual data parameters related to a primary desktop associated with the user. Further, the method includes provisioning one of the one or more secondary desktops in the remote site as the personalized desktop for the user based on the one or more primary contextual data parameters.

Further, the present disclosure discloses a desktop provisioning system to dynamically provision a personalized desktop to a user in a remote site. The desktop provisioning system comprises a processor and a memory. The memory is communicatively coupled to the processor. Further the memory stores processor-executable instructions, which, on execution, causes the processor to identify the user in the remote site based on profile information of the user. The remote site includes one or more secondary desktops. Upon identifying the user in the remote site, the processor collects one or more primary contextual data parameters related to a primary desktop associated with the user. Finally, the processor provisions one of the one or more secondary desktops in the remote site as the personalized desktop for the user based on the one or more primary contextual data parameters.

Furthermore, the present disclosure relates to a non-transitory computer readable medium including instructions stored thereon that when processed by a desktop provisioning system performs operations comprising identifying the user in the remote site based on profile information of the user. The remote site comprises one or more secondary desktops. Upon identifying the user, the instructions cause the desktop provisioning system to collect one or more primary contextual data parameters related to a primary desktop associated with the user. Finally, the instructions cause the desktop provisioning system to provision one of the one or more secondary desktops in the remote site as the personalized desktop for the user based on the one or more primary contextual data parameters.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, explain the disclosed principles. In the figures, the left-most digit(s) or a reference number identities the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 shows an exemplary environment for dynamically provisioning a personalized desktop to user in a remote site in accordance with some embodiments of the present disclosure;

FIG. 2 shows a detailed block diagram illustrating a desktop provisioning system for dynamically provisioning the personalized desktop in accordance with some embodiments of the present disclosure;

FIG. 3A shows a sequence diagram illustrating a method of dynamically provisioning the personalized desktop to the user in accordance with one or more embodiments of the present disclosure;

FIG. 3B shows a sequence diagram illustrating a method of terminating a user session on the provisioned desktop in accordance with few embodiments of the present disclosure;

FIG. 3C and FIG. 3D depict an exemplary illustration of dynamically provisioning a personalized desktop to a user in the remote site;

FIG. 4 shows a flowchart illustrating a method for dynamically provisioning a personalized desktop to user in a remote site in accordance with some embodiments of the present disclosure; and

FIG. 5 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, “includes”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to a method and a desktop provisioning system for dynamically provisioning a personalized desktop to a user in a remote site. The capabilities and configuration details of a primary desktop of the user are automatically identified by the desktop provisioning system to determine feasibility of providing a secondary desktop to the user in the remote site. Upon identifying the secondary desktop, the identified temporary secondary desktop may be equipped with user specific requirements based on profile information of the user, thereby providing secondary desktop, alternatively referred as a substitute system having similar capabilities and configurations as that of the user's primary desktop.

Further, the method disclosed in the present disclosure also comprises alerting or notifying the user about the availability of the secondary desktop in the remote site, when the user visits the remote site. In some embodiments, once the user accepts the notification, the identified secondary desktop is automatically configured as per the user's primary desktop with the help of the desktop provisioning system. Further, the access details of the secondary desktop are provided to the user though one or more user devices associated with the user.

Furthermore, the present disclosure also discloses tracking and updating the profile information of the user after terminating the user's session on the secondary desktop. In some embodiments, one or more secondary desktops in one or more different remote locations may be interlinked and collaborated with each other to synchronize profile information of the user based on the one or more activities performed by the user on each of those one or more secondary desktops. This enables the user to use a secondary desktop, which has similar/equivalent capabilities of the primary desktop on the fly and it improves the efficiency and user-experience of the user in the remote site.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

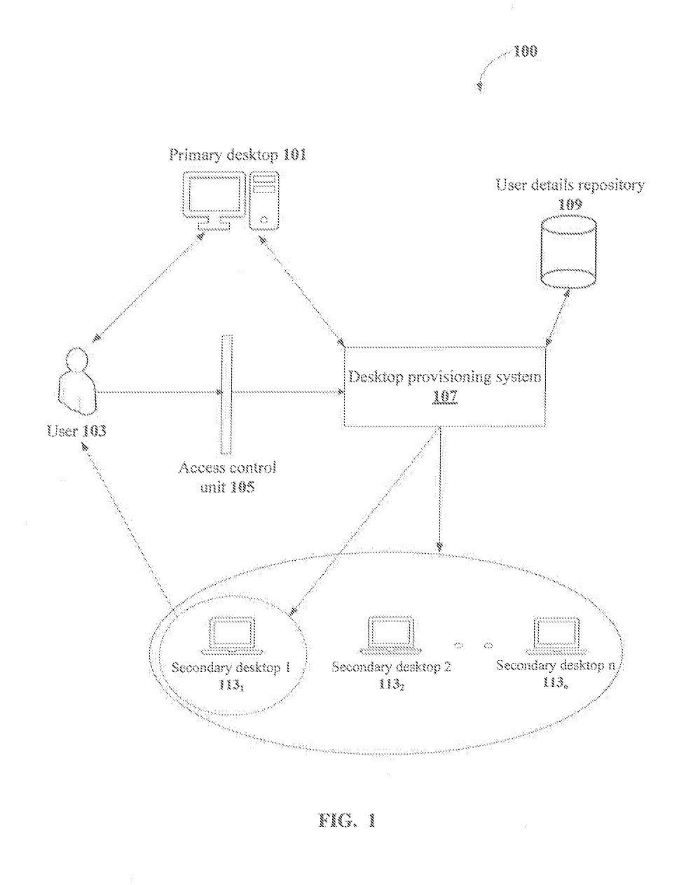

FIG. 1 shows an exemplary environment for dynamically provisioning a personalized desktop to user in a remote site in accordance with some embodiments of the present disclosure.

The environment 100 comprises a desktop provisioning system 107 for dynamically provisioning a personalized desktop to the user in the remote site. In some embodiments, whenever the user visits a remote site for accomplishing a given work-assignment, the user must authenticate himself with an access control unit 105 in the remote site, before the user can start working on the assignment. As an example, the access control unit 105 may include a biometric user identification technique, RFID tags, an electronic key mechanism or a swipe-in machine that authenticates the user when the user swipes an identification (ID) card through the swipe-in machine and the like. Accordingly, as soon as the user requests an access to enter the remote site, the access control unit 105 authenticates the user based on one or more login credentials associated with the user.

In some embodiments, upon successful authentication of the user, the access control unit 105 notifies the desktop provisioning system 107 about the presence of the user in the remote site. Later, the desktop provisioning system 107 identifies the user in the remote site by comparing the one or more user login credentials with information stored in a user details repository 109 associated with the desktop provisioning system 107. The user details repository 109 may be a centralized repository that stores profile information of all the users/employees across all locations of an enterprise. As an example, the profile information may include, without limiting to, contact details of the user, details of a primary site of the user and information related to a working domain of the user.

Once the user has been identified by the desktop provisioning system 107, the desktop provisioning system 107 collects one or more primary contextual data parameters 211 from a primary desktop 101 of the user. The primary desktop 101 may be a desktop which is regularly used by the user. As an example, the one or more primary contextual data parameters 211 may include, without limiting to, configuration details of the primary desktop 101 and information related to one or more user specific applications configured in the primary desktop 101. Now, based on the one or more primary contextual data parameters 211 collected from the primary site, the desktop provisioning system 107 may scan through each of one or more secondary desktops, secondary desktop 113₁ to secondary desktop 113n (collectively referred as one or more secondary desktops 113) in the remote site, for selecting one of the one or more secondary desktops 113 as the personalized desktop to the user. Here, one of the one or more secondary desktops 113 may be provisioned as the personalized desktop only if the one or more contextual data parameters related to the one of the one or more secondary desktops 113 is similar to the one or more primary contextual data parameters 211.

After selecting the one of the one or more secondary desktops 113 in the remote site, the desktop provisioning system 107 provisions the selected one of the one or more secondary desktops 113 as the personalized desktop to the user. Finally, the desktop provisioning system 107 communicates one or more provisioning data 213 to the user through one or more user devices associated with the user for notifying the user about the availability of the personalized desktop in the remote site. As an example, the one or more provisioning data 213 may include, without limiting to, configuration details of the personalized desktop and location details of the personalized desktop.

In some embodiments, once the user has completed work on the remote site, the user may log-off from the personalized desktop. In these scenarios, the desktop provisioning system 107 terminates the user session on the personalized desktop upon determining one of an idle condition of the personalized desktop for a predetermined threshold period or when the desktop provisioning system 107 receives a user session log-off request from the user. Finally, the desktop provisioning system 107 updates the profile information of the user upon termination of the user session, based on one or more activities performed by the user on the personalized desktop during the user session. The updated profile information of the user may be stored back in the user details repository 109.

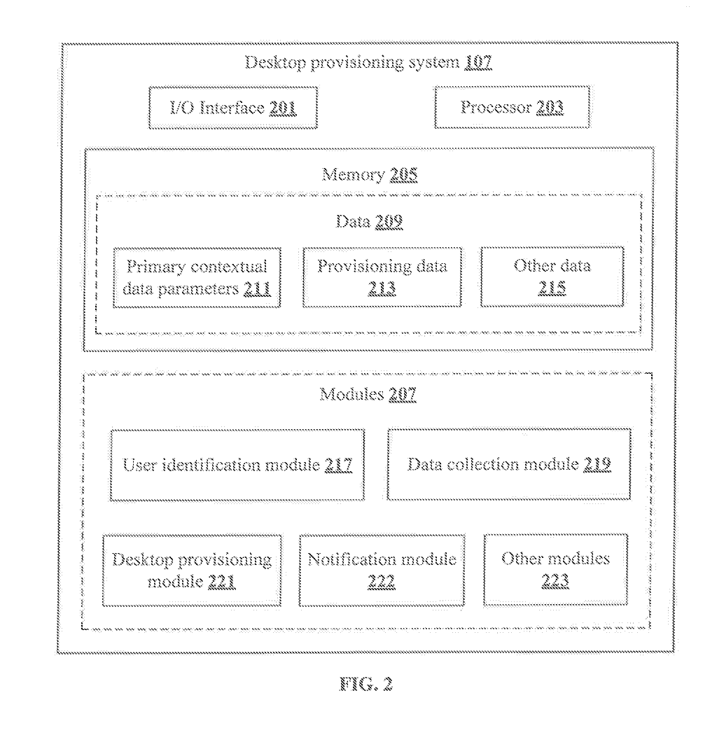

FIG. 2 shows a detailed block diagram illustrating a desktop provisioning system for dynamically provisioning the personalized desktop in accordance with some embodiments of the present disclosure.

The desktop provisioning system 107 comprises an I/O interface 201, a processor 203 and a memory 205. The I/O interface 201 may be configured to collect one or more primary contextual data parameters 211 related to the primary desktop 101 of the user. The memory 205 may be communicatively coupled to the processor 203. The processor 203 may be configured to perform one or more functions of the desktop provisioning system 107 for dynamically provisioning the personalized desktop to the user in the remote site. In one implementation, the desktop provisioning system 107 may comprise data 209 and modules 207 for performing various operations in accordance with the embodiments of the present disclosure. In an embodiment, the data 209 may be stored within the memory 205 and may include, without limiting to, primary contextual data parameters 211, provisioning data 213 and other data 215.

In some embodiments, the data 209 may be stored within the memory 205 in the form of various data structures. Additionally, the data 209 may be organized using data models, such as relational or hierarchical data models. The other data 215 may store data, including temporary data and temporary files, generated by modules 207 for performing the various functions of the desktop provisioning system 107.

In some embodiments, the one or more primary contextual data parameters 211 may include the one or more data parameters related to the primary desktop 101 associated with the user, which are collected from the primary desktop 101 upon identifying the user in the remote site. As an example, the one or more primary contextual data parameters 211 may include, without limiting to, configuration details of the primary desktop 101 and information related to the one or more user specific applications configured in the primary desktop 101. The one or more primary contextual data parameters 211 are considered as a reference for selecting one of the one or more secondary desktops 113 as the personalized desktop to the user. In one embodiment, the one or more contextual data parameters associated with each of the one or more secondary desktops 113 are compared with the one or more primary contextual data parameters 211 for identifying one of the one or more secondary desktops 113 having most similar configurations as that of the primary desktop 101 of the user.

Additionally, the one or more primary contextual data parameters 211 may be updated upon determining that the user's session on the personalized desktop is terminated. The one or more primary contextual data parameters 211 are updated based on the one or more activities of the user on the personalized desktop during the user session.

In some embodiments, the one or more provisioning data 213 may include various information provided to the user once the provisioning of the personalized desktop is successful. As an example, the one or more provisioning data 213 provided to the user may include, without limitation, configuration details of the personalized desktop and the location information of the personalized desktop. Further, the one or more provisioning data 213 may be communicated to the user through the one or more user devices associated with the user. Communicating the one or more provisioning data 213 to the user would also serve the purpose of notifying the user about the availability of the personalized desktop in the remote site.

In some implementations, the one or more provisioning data 213 may also include a ‘user acceptance request’, along with the configuration details and the location information of the personalized desktop. The ‘user acceptance request’ prompts the user to accept the configurations of the personalized desktop and thereby instructing the desktop provisioning system 107 to set-up the personalized desktop in the remote site. In such scenarios, the personalized desktop would be configured only when the user accepts the ‘user acceptance request’. The process of transmitting the ‘user acceptance request’ to the user and then receiving the user's acceptance for provisioning the personalized desktop would bring an additional level of security in the desktop provisioning process.

In some embodiments, the data 209 may be processed by one or more modules 207 of the desktop provisioning system 107. In one implementation, the one or more modules 207 may be stored as a part of the processor 203. In another implementation, the one or more modules 207 may be communicatively coupled to the processor 203 for performing one or more functions of the desktop provisioning system 107. The modules 207 may include, without limiting to, a user identification module 217, a data collection module 219, a desktop provisioning module 221, a notification module 222 and other modules 223.

As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality. In an embodiment, the other modules 223 may be used to perform various miscellaneous functionalities of the desktop provisioning system 107. It will be appreciated that such modules 207 may be represented as a single module or a combination of different modules.

The user identification module 217 may be responsible for identifying the user in the remote site based on the profile information of the user. Initially, the user identification module 217 receives the one or more user login credentials from the access control unit 105 in the remote site. Later, the user identification module 217 compares the one or more user login credentials with information stored in the user details repository 109 associated with the desktop provisioning system 107.

In an implementation, the user identification module 217 is communicatively configured with the access control unit 105 for receiving the login credentials of the user and to identify the user in the remote site. The access control unit 105 may be responsible for controlling the user access into one or more remote site premises. The access control unit 105 may comprise one or more swiping machines at each of the one or more remote sites. Each of the one or more swiping machines are centrally managed by the access control unit 105 to handle each user access requests.

For example, when a user swipes an identity card at the swiping machine placed at one of the remote sites, a notification would be provided to the access control unit 105. Then, the access control unit 105 would verify the one or more login credentials of the user based on the information stored in an access control database associated with the access control unit 105. Further, the access control unit 105 would direct a gate control mechanism associated with the remote site to either allow or reject the user to get inside the premises of the remote site. In some implementations, the access control unit 105 may transmit a notification to the user identification module 217, indicating that the user access was successful. Upon receiving the notification from the access control unit 105, the user identification module 217 may interact with the user details repository 109 to fetch the profile information of the user. As an example, some of the parameters in the profile information that are required to identify the user may include, without limiting to, a user name (login ID), details of primary site of the user and contact details of the user.

In some embodiments, the data collection module 219 may be responsible for collecting the one or more primary contextual data parameters 211 related to the primary desktop 101 associated with the user upon identifying the user in the remote site. The data collection module 219 may interact with the primary desktop 101 of the user, which is configured in the primary site, to get the configuration details of the user's primary desktop 101. As an example, the one or more primary contextual data parameters 211 may include, without limiting to, configuration details of the primary desktop 101 and the information related to the one or more user specific applications configured in the primary desktop 101.

In some implementations, the data collection module 219 may simultaneously communicate with the primary desktop 101 at the primary site and the one or more secondary desktops 113 in the remote site to understand the one or more contextual data parameters about the primary desktop 101 and to identify one of the one or more secondary desktops 113 in the remote site having similar capabilities and configurations as that of the primary desktop 101. The data collection module 219 may make use any standard type of network protocol for establishing a communication with the primary desktop 101 and the one or more secondary desktops 113.

In some embodiments, the desktop provisioning module 221 may be responsible for provisioning one of the one or more secondary desktops 113 in the remote site as the personalized desktop for the user based on the one or more primary contextual data parameters 211. The one of the one or more secondary desktops 113 may be provisioned as the personalized desktop only when the one or more contextual data parameters related to the one of the one or more secondary desktops 113 are similar to the one or more primary contextual data parameters 211 of the primary desktop 101 of the user.

In some embodiments, the desktop provisioning system 107 may configure and interface the one of the one or more secondary desktops 113 as the personalized desktop to the user, only upon receiving the user's acceptance for the ‘user acceptance request’, which is transmitted to the user along with the one or more provisioning data 213. In some embodiments, the desktop provisioning system 107 may provision the secondary desktops 113 that are similar to the primary desktop 101, from virtual machine in virtual desktop infrastructure.

In some embodiments, the notification module 222 may be responsible for setting up communication and/or exchanging various notifications between the user, the primary desktop 101 and the desktop provisioning system 107. For example, the notification module 222 may notify the user about the availability of the personalized desktop in the remote site. Further, the notification module 222 would help in enhancing the overall user experience of the user by notifying the location details of the personalized desktop in the remote site. Additionally, the medium of communication between the desktop provisioning system 107 and the use can be a mobile based corporate email system or Mobile based SMS system etc.

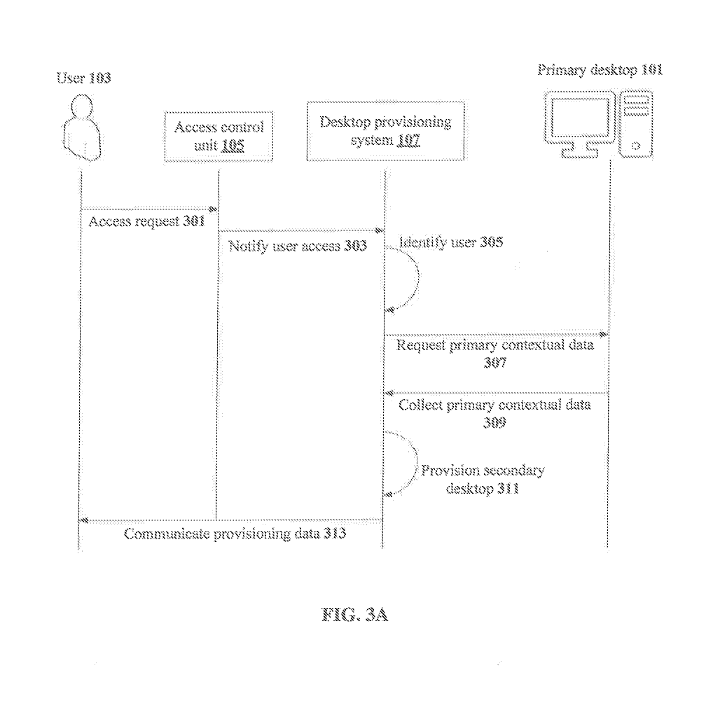

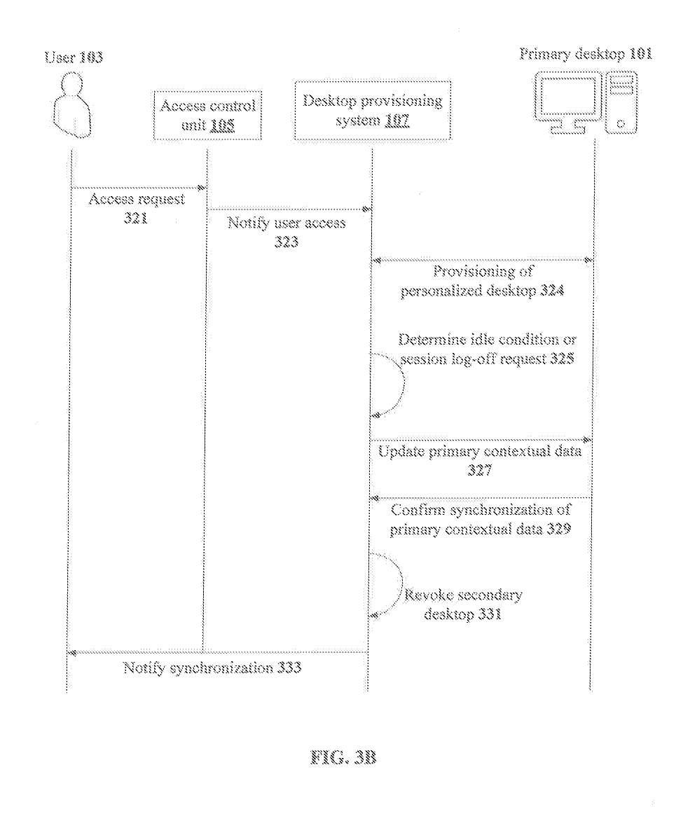

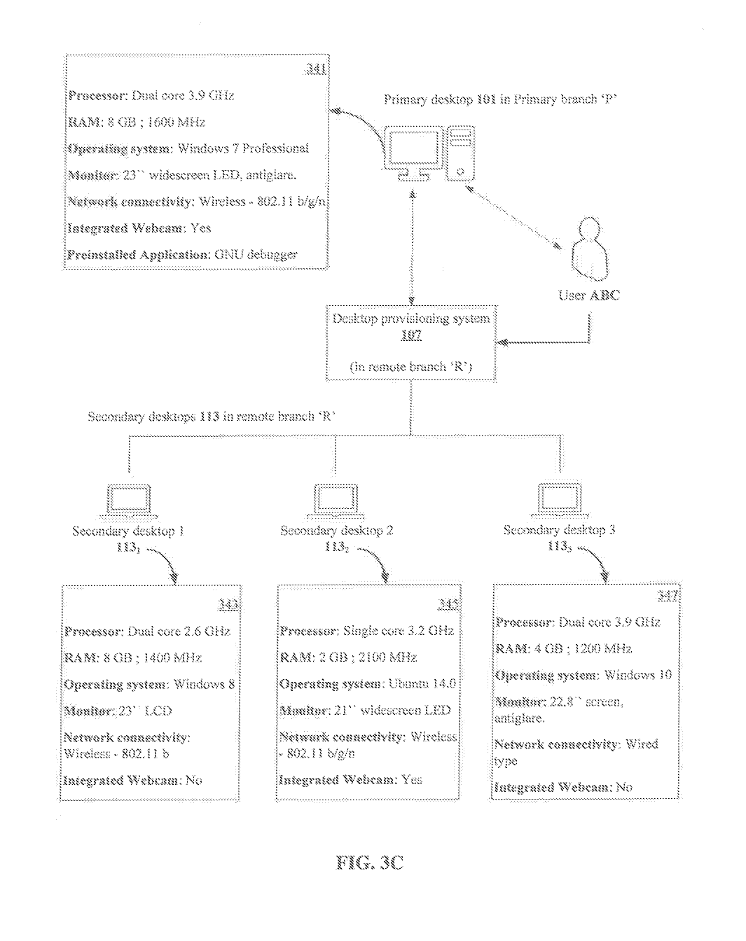

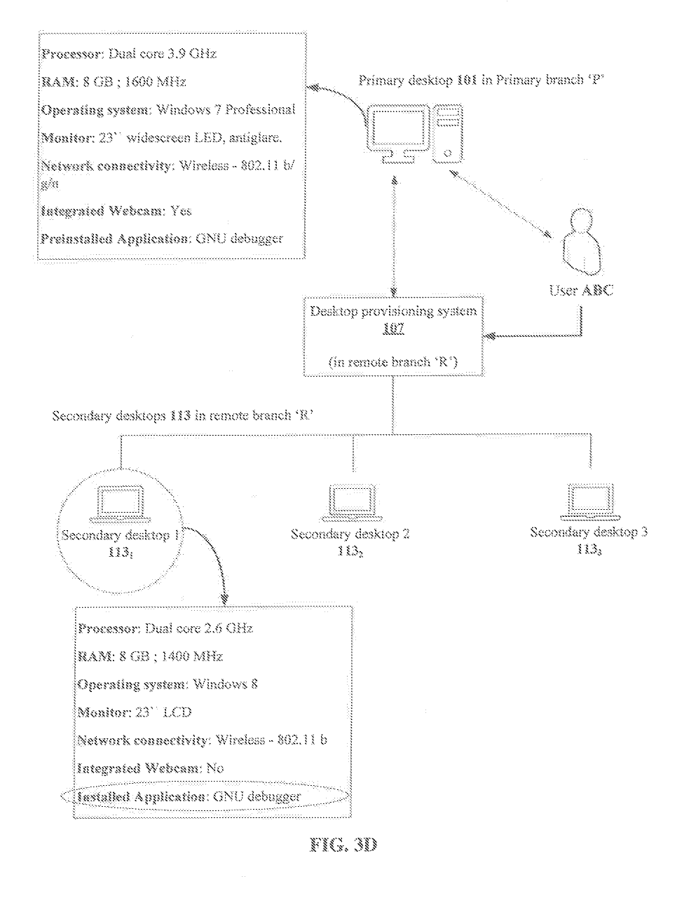

FIG. 3A shows a sequence diagram illustrating a method of dynamically provisioning the personalized desktop to the user in accordance with few embodiments of the present disclosure.

At step 301, the user may request an access permission to enter the remote site. Upon receiving the access request from the user, the access control unit 105 associated with the desktop provisioning system 107 would authenticate the user by verifying the one or more login credentials provided by the user. At step 303, the access control unit 105 would notify the desktop provisioning system 107 about the new user login to the remote site, once the user is successfully authenticated in step 301. At step 305 the desktop provisioning system 107 identifies the user in the remote site by receiving one or more user login credentials from the access control unit 105 and comparing the one or more user login credentials with the information stored in the user details repository 109. Once the user is identified by the desktop provisioning system 107, at step 307, the desktop provisioning system 107 communicates with the primary desktop 101 of the user, requesting to receive one or more primary contextual data parameters 211 associated with the primary desktop 101. At step 309, the desktop provisioning system 107 receives the one or more primary contextual data parameters 211 from the primary desktop 101. The one or more primary contextual data parameters 211, thus collected from the primary desktop 101 may indicate the configuration and capabilities of the primary desktop 101.

Further, at step 311, the desktop provisioning system 107 scans through the one or more contextual parameters associated with the one or more secondary desktops 113 that are present in the remote site to determine one of the one or more secondary desktops 113 as the personalized desktop for the user. Here, the one or more contextual data parameters related to the one or more secondary desktops 113 are compared with the one or more primary contextual data parameters 211 which are collected from the primary desktop 101 to identify the one of the one or more secondary desktops 113 having most similar configuration and capabilities as that of the primary desktop 101. After identifying similar one of the one or more secondary desktops 113, the desktop provisioning system 107 provisions the similar one of the one or more secondary desktops 113 as the personalized desktop to the user. Finally, at step 313, the desktop provisioning system 107 communicates the one or more provisioning data 213 to the user by transmitting notifications to the one or more user devices associated with the user. As an example, the notification provided to the user may comprise the details of location in which the personalized desktop is provisioned and the configuration details of the personalized desktop.

FIG. 3B shows a sequence diagram illustrating a method of terminating a user session on the provisioned desktop in accordance with few embodiments of the present disclosure.

As disclosed in FIG. 3A, at step 321, the user may request the access permission to enter the remote site. Upon receiving the access request from the user, the access control unit 105 associated with the desktop provisioning system 107 would authenticate the user by verifying the one or more login credentials provided by the user. At step 323, the access control unit 105 would notify the desktop provisioning system 107 about the new user login to the remote site, once the user is successfully authenticated in step 321. Further, at step 324, the desktop provisioning system 107 would provision the personalized desktop to the user by performing the sequence of operations disclosed in steps 305-311 in FIG. 3A.

In some embodiments, the user may temporarily log-off from the personalized desktop after working on the personalized desktop for required duration of time. Alternatively, the personalized desktop may be left idle when the user is busy with other work assignments and is not working on the personalized desktop. In such scenarios, the desktop provisioning system 107 may detect the end of the user's session on the personalized desktop and may synchronize and/or update the profile information of the user based on the user session by performing the sequence of actions in step 325-331 as shown in FIG. 3B.

At step 325, the desktop provisioning system 107 may monitor the personalized desktop to determine at least one of the idle condition of the personalized desktop for a predetermined threshold time or receipt of a user session log-off request from the user. As an example, once the swipe-off notification is received from the access control unit 105, an auto cutoff timer may be triggered by the desktop provisioning system 107. When the auto cutoff timer reaches the predetermined threshold time, say one hour, the desktop provisioning system 107 would terminate the user session on the personalized desktop.

On the other hand, if the new swipe-in does not happen within the preconfigured threshold time, say for more than five days, then the desktop provisioning system 107 may terminate the user session on the personalized desktop, and the cutoff timer would be reset. In some embodiments, the desktop provisioning system 107 may run a check on the personalized desktop to find out the time since last usage of the personalized desktop by the user. If the time since the last usage is more than a threshold time, say for more than two days, then the active instance of the personalized desktop would be terminated by the desktop provisioning system 107.

Once the user session on the personalized desktop is terminated, at step 327, the desktop provisioning system 107 updates the primary desktop 101 of the user based on the one or more activities performed by the user on the personalized desktop during the user session. As an example, suppose, the user has installed a new application on the personalized desktop for accomplishing a given work assignment, while the user was there in the remote site. Now, upon termination of the user session on the personalized desktop, the desktop provisioning system 107 would recognize the newly installed application on the personalized desktop and would update the primary desktop 101 of the user by installing the same application on the primary desktop 101, thereby ensuring that both the personalized desktop and the primary desktop 101 are in synchronization in terms of their configurations and capabilities.

Further, at step 329, after completion of the synchronization activity on the primary desktop 101, a synchronization agent on the primary desktop 101 would notify the desktop provisioning system 107 to indicate that the synchronization process is complete. Upon receiving the confirmation on the synchronization, at step 331, the desktop provisioning system 107 initiates revocation of the personalized desktop by wiping off the personalized desktop. Finally, at step 333, the desktop provisioning system 107 may transmit a notification to the user, indicating that the personalized desktop has been revoked and the primary desktop 101 has been synchronized as per the one or more activities performed by the user on the personalized desktop during the user session.

FIG. 3C and FIG. 3D depict an exemplary illustration of dynamically provisioning a personalized desktop to a user in the remote site.

Consider a user ‘ABC’ who is a software testing engineer in a company ‘XYZ’ and regularly works at the primary desktop 101 which is present in a primary branch ‘P’ (main branch) of the company ‘XYZ’. As an example, the configuration details of the primary desktop 101 of the user ‘ABC’ may be as indicated in block 341. As shown in block 341, the primary desktop 101 may be configured with a ‘Dual core—3.9 GHz’ processor with an ‘8 GB’ RAM at ‘1600 MHz’, running on a ‘Windows 7 Professional’ operating system. The monitor of the primary desktop 101 may be a ‘23 inches’ wide screen with LED and antiglare finishing. The primary desktop 101 may be configured to support wireless network connectivity per ‘802.11b/g/n’ standards. Further, the primary desktop 101 may have an integrated webcam that would help the user ‘ABC’ to conduct a Video Conference (VC) whenever required. Additionally, the primary desktop 101 may be configured with ‘GNU debugger’, which is an application that would help the user ‘ABC’ to carry out various testing and debugging tasks during the user's work assignments. Here, the ‘GNU debugger’ is a user specific application, which is installed by the user ‘ABC’ on the primary desktop 101 as per the user's convenience and expertise in using the ‘GNU debugger’.

Suppose, to accomplish a given work assignment, the user ‘ABC’ must travel to a different branch, for example, a remote branch ‘R’ of the company ‘XYZ’. In such a scenario, upon successful authentication and identification of the user ‘ABC’ in the remote branch ‘R’, the desktop provisioning system 107 present in the remote branch ‘R’ would scan through each of the one or more secondary desktops 113 in the remote branch ‘R’ to identify one of the one or more secondary desktops 113 having similar configuration as that of the primary desktop 101. As an example, consider that the remote branch ‘R’ includes 3 secondary desktops, namely secondary desktop 1 113₁, secondary desktop 2 113₂ and secondary desktop 3 113₃. Further, blocks 343, 345 and 347 indicate the configuration of the secondary desktop 1 113₁, secondary desktop 2 113₂ and the secondary desktop 3 113₃ respectively.

Initially, the desktop provisioning system 107 may collect the one or more primary contextual data parameters 211 i.e. configurations of the primary desktop 101 and then compare the one or more primary contextual data parameters 211 with the configuration of the secondary desktops 113 in the remote branch ‘R’. Upon comparison, for example, the desktop provisioning system 107 may select the secondary desktop 1 113₁ for provisioning the secondary desktop 1 113₁ as the personalized desktop to the user ‘ABC’, since the configuration details of the secondary desktop 1 113₁ are similar to the configuration details of the primary desktop 101. In other words, the processor (Dual core 2.6 GHz), memory (8 GB RAM at 1400 MHz) and network connection (Wireless per 802.11 b standard) capabilities of the secondary desktop 1 113₁ are close to the respective capabilities of the primary desktop 101. The operating system and the monitor configurations on the secondary desktop 1 113₁ are slightly different from the primary desktop 101, however, the difference are not predominant, considering the nature and/or work domain of the user ‘ABC’.

In the above example, the secondary desktop 2 113₂ and the secondary desktop 3 113₃ may not be selected as the personalized desktop to the user ‘ABC’ for following reasons. For instance, the user ‘ABC’ may not be comfortable for working on the secondary desktop 2 113₂, since the secondary desktop 2 113₂ runs on a Linux based ‘Ubuntu 14.0’ operating system. Similarly, the secondary desktop 3 113₃ may not provisioned for the user ‘ABC’ since the secondary desktop 3 113₃ do not support wireless network connectivity, which may be a predominant requirement of the user ‘ABC’.

Finally, the desktop provisioning system 107 selects the secondary desktop 1 113₁ as the personalized desktop to the user ‘ABC’ based on the comparison of the configuration details of the secondary desktop 1 113₁ and the configuration details of the primary desktop 101. Further, the desktop provisioning system 107 may install the user specific application—‘GNU debugger’ on the personalized desktop (secondary desktop 1 113₁), thereby recreating a closest computing environment on the personalized desktop, which is similar to the primary desktop 101 of the user ‘ABC’.

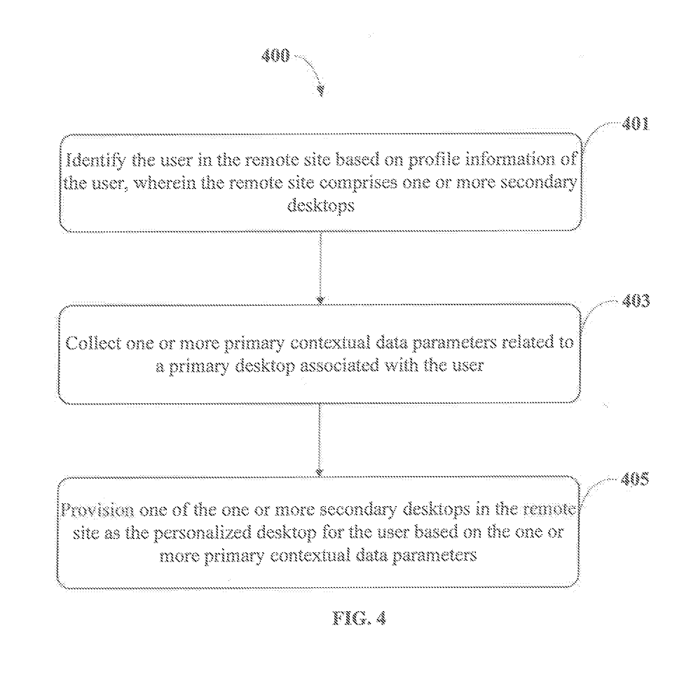

FIG. 4 shows a flowchart illustrating a method for dynamically provisioning a personalized desktop to user in a remote site in accordance with some embodiments of the present disclosure.

As illustrated in FIG. 4, the method 400 comprises one or more blocks for dynamically provisioning a personalized desktop to a user in a remote site using a desktop provisioning system 107. The method 400 may be described in the general context of computer executable instructions. Generally, computer executable instructions can include routines, programs, objects, components, data structures, procedures, modules, and functions, which perform specific functions or implement specific abstract data types.

The order in which the method 400 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 401, the desktop provisioning system 107 identifies the user in the remote site based on profile information of the user. The remote site includes one or more secondary desktops 113. Identifying the user further comprises receiving one or more user login credentials from an access control unit 105 in the remote site. Upon receiving the one or more login credentials, the one or more user login credentials is compared with the information stored in a user details repository 109 associated with the desktop provisioning system 107. In an embodiment, the user profile information may comprise at least one of a name of the user, contact details of the user, details of a primary site of the user and information related to a working domain of the user and the like.

At block 403, the desktop provisioning system 107 collects one or more primary contextual data parameters 211 related to a primary desktop 101 associated with the user. In an embodiment, the one or more primary contextual data parameters 211 may comprise at least one of configuration details of the primary desktop 101 and information related to one or more user specific applications configured in the primary desktop 101.

At block 405, the desktop provisioning system 107 provisions one of the one or more secondary desktops 113 in the remote site as the personalized desktop for the user based on the one or more primary contextual data parameters 211. In some embodiments, the desktop provisioning system 107 provisions one of the one or more secondary desktops 113 as the personalized desktop, only if one or more contextual data parameters related to the one of the one or more secondary desktops 113 is similar to the one or more primary contextual data parameters 211.

In some embodiments, the desktop provisioning system 107 transmits one or more provisioning data 213 to the user through one or more user devices associated with the user. As an example, the one or more provisioning data 213 comprises at least one of configuration details of the personalized desktop and location details of the personalized desktop.

Finally, the desktop provisioning system 107 terminates a user session on the personalized desktop upon determining one of an idle condition of the personalized desktop for a predetermined threshold period and a user session log-off request from the user. In some embodiments, the one or more primary contextual data parameters 211 are updated upon termination of the user session based on one or more activities performed by the user on the personalized desktop during the user session.

Computer System

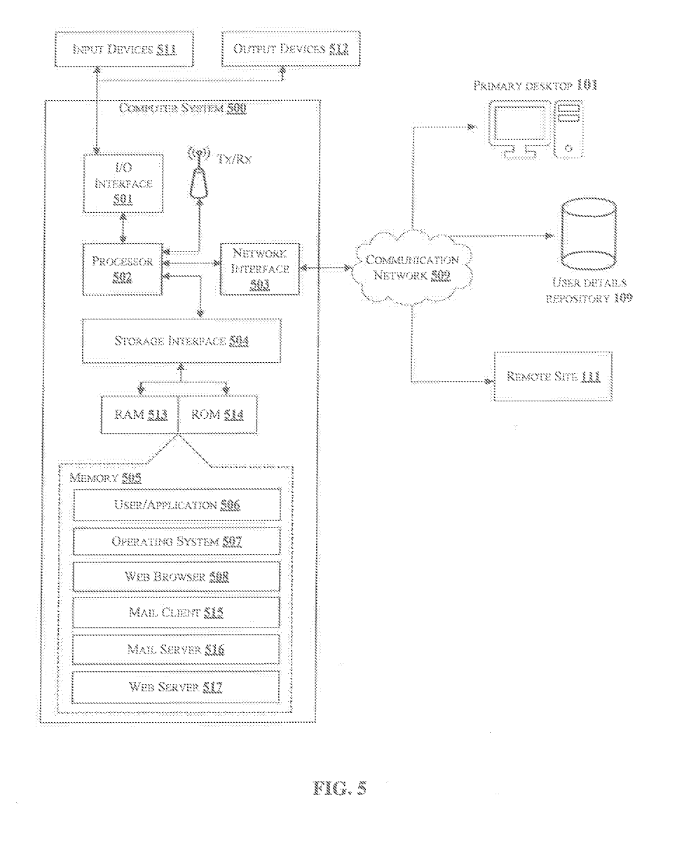

FIG. 5 illustrates a block diagram of an exemplary computer system 500 for implementing embodiments consistent with the present invention. In an embodiment, the computer system 500 may be the desktop provisioning system 107 which is used for dynamically provisioning a personalized desktop to a user in a remote site. The computer system 500 may comprise a central processing unit (“CPU” or “processor”) 502. The processor 502 may comprise at least one data processor for executing program components for executing user- or system-generated business processes. A user may include a person, a person using a device such as such as those included in this invention, or such a device itself. The processor 502 may include specialized processing units such as integrated system (bus) controllers, memory management control units, floating point units, graphics processing units, digital signal processing units, etc.

The processor 502 may be disposed in communication with one or more input/output (I/O) devices (511 and 512) via I/O interface 501. The I/O interface 501 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc.

Using the I/O interface 501, the computer system 500 may communicate with one or more I/O devices (511 and 512). In some embodiments, the processor 502 may be disposed in communication with a communication network 509 via a network interface 503. The network interface 503 may communicate with the communication network 509. The network interface 503 may employ connection protocols including, without limitation, direct connect, Ethernet (e,g., twisted pair 10/100/1000 Base T), Transmission Control Protocol/Internet Protocol (TCP/IP), token ring, IEEE 802.11a/b/g/n/x, etc. Using the network interface 503 and the communication network 509, the computer system 500 may communicate with a primary desktop 101 associated with the user for collecting one or more one or more primary contextual data parameters 211 related to a primary desktop 101. Also, the computer system 500 may communicate with a user details repository 109 and remote site for collecting information required for provisioning the personalized desktop to the user in the remote site. The communication network 509 can be implemented as one of the different types of networks, such as intranet or Local Area Network (LAN) and such within the organization. The communication network 509 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 509 may include a variety of network devices, including routers, bridges, servers, computing devices, storage devices, etc.

In some embodiments, the processor 502 may be disposed in communication with a memory 505 (e.g., RAM 513, ROM 514, etc. as shown in FIG. 5) via a storage interface 504. The storage interface 504 may connect to memory 505 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel. Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user/application 506, an operating system 507, web browser 508 etc. In some embodiments, computer system 500 may store user/application data 506, such as the data, variables, records, etc. as described in this invention. Such databases may be implemented as fault-tolerant, relational, scalable, secure databases such as Oracle or Sybase.

The operating system 507 may facilitate resource management and operation of the computer system 500. Examples of operating systems include, without limitation, Apple Macintosh OS X, UNIX, Unix-like system distributions (e.g., Berkeley Software Distribution (BSD), FreeBSD, Net BSD, Open BSD, etc.), Linux distributions (e.g., Red Hat, Ubuntu, K-Ubuntu, etc.), International Business Machines (IBM) OS/2, Microsoft Windows (XP, Vista/7/8, etc.), Apple iOS, Google Android, Blackberry Operating System (OS), or the like. A user Interface may facilitate display, execution, interaction, manipulation, or operation of program components through textual or graphical facilities. For example, user interfaces may provide computer interaction interface elements on a display system operatively connected to the computer system 500, such as cursors, icons, check boxes, menus, windows, widgets, etc. Graphical User Interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e,g., ActiveX, Java, JavaScript, AJAX, HTML, Adobe Flash, etc.), or the like.

In some embodiments, the computer system 500 may implement a web browser 508 stored program component. The web browser 508 may be a hypertext viewing application, such as Microsoft Internet Explorer, Google Chrome, Mozilla Firefox, Apple Safari, etc. Secure web browsing may be provided using Secure Hypertext Transport Protocol (HTTPS) secure sockets layer (SSL), Transport Layer Security (TLS), etc. Web browsers may utilize facilities such as AJAX, DHTML, Adobe Flash, JavaScript, Java, Application Programming Interfaces (APIs), etc. In some embodiments, the computer system 500 may implement a mail server stored program component. The mail server 516 may be an Internet mail server such as Microsoft Exchange, or the like. The mail server 516 may utilize facilities such as Active Server Pages (ASF), ActiveX, American National Standards Institute (ANSI) C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 500 may implement a mail client 515 stored program component. The mail client 515 may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives. Compact Disc (CD) ROMs, Digital Video Disc (DVDs), flash drives, disks, and any other known physical storage media.

Advantages of the Embodiment of the Present Disclosure are Illustrated Herein.

In an embodiment, the present disclosure provides a method for automatically identifying a roaming user on a remote site and to automatically initiate actions required for provisioning a desktop in the remote site, which is as good as the user's primary desktop at the primary location.

In an embodiment, the present disclosure improves the user experience of a roaming user by automatically handling data synchronization and desktop revocation mechanism of the secondary desktop.

In an embodiment, the method of present disclosure can send a notification to the user about the availability of the secondary desktop at the remote site, thereby enhancing the user experience.

In an embodiment, the method of present disclosure enhances the work efficiency of the roaming users by facilitating the roaming users with the secondary desktops that have similar configurations and capabilities as that of the user's primary desktop.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise. A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference Number | Description |
|---|---|
| 100 | Environment |
| 101 | Primary desktop |
| 105 | Access control unit |
| 107 | Desktop provisioning system |
| 109 | User details repository |
| 113 | One or more secondary desktops |
| 201 | I/O Interface |
| 203 | Processor |
| 205 | Memory |
| 207 | Modules |
| 209 | Data |
| 211 | Primary contextual data parameters |
| 213 | Provisioning data |
| 215 | Other data |
| 217 | User identification module |
| 219 | Data collection module |
| 221 | Desktop provisioning module |
| 222 | Notification module |
| 223 | Other modules |

What is claimed is:

1. A method of dynamically provisioning a personalized desktop to a user in a remote site, the method comprising:
identifying, by a desktop provisioning system (107), the user in the remote site based on profile information of the user, wherein the remote site comprises one or more secondary desktops (113);
collecting, by the desktop provisioning system (107), one or more primary contextual data parameters (211) related to a primary desktop (101) associated with the user; and
provisioning, by the desktop provisioning system (107), one of the one or more secondary desktops (113) in the remote site as the personalized desktop for the user based on the one or more primary contextual data parameters (211).

2. The method as claimed in claim 1, wherein the user profile information comprises at least one of a name of the user, contact details of the user, details of a primary site of the user and information related to a working domain of the user.

3. The method as claimed in claim 1, wherein identifying the user comprises:
receiving, by the desktop provisioning system (107), one or more user login credentials from an access control unit (105) in the remote site; and
comparing, by the desktop provisioning system (107), the one or more user login credentials with information stored in a user details repository (109) associated with the desktop provisioning system (107).

4. The method as claimed in claim 1, wherein the one or more primary contextual data parameters (211) comprises at least one of configuration details of the primary desktop (101) and information related to one or more user specific applications configured in the primary desktop (101).

5. The method as claimed in claim 1, wherein one of the one or more secondary desktops (113) is provisioned as the personalized desktop if one or more contextual data parameters related to the one of the one or more secondary desktops (113) is similar to the one or more primary contextual data parameters (211).

6. The method as claimed in claim 1 further comprises communicating one or more provisioning data (213) to the user through one or more user devices associated with the user.

7. The method as claimed in claim 6, wherein the one or more provisioning data (213) comprises at least one of configuration details of the personalized desktop and location details of the personalized desktop.

8. The method as claimed in claim 1 and further comprising terminating a user session on the personalized desktop upon determining one of an idle condition of the personalized desktop for a predetermined threshold period and a user session log-off request from the user.

9. The method as claimed in claim 8 and further comprising updating the one or more primary contextual data parameters (211) upon termination of the user session based on one or more activities performed by the user on the personalized desktop during the user session.

10. A desktop provisioning system (107) for dynamically provisioning a personalized desktop to a user in a remote site, the desktop provisioning system (107) comprising;
a processor (203); and
a memory (205), communicatively coupled to the processor (203), wherein the memory (205) stores processor-executable instructions, which, on execution, causes the processor (203) to:
identify the user in the remote site based on profile information of the user, wherein the remote site comprises one or more secondary desktops (113);
collect one or more primary contextual data parameters (211) related to a primary desktop (101) associated with the user; and
provision one of the one or more secondary desktops (113) in the remote site as the personalized desktop for the user based on the one or more primary contextual data parameters (211).

11. The desktop provisioning system (107) as claimed in claim 10, wherein the user profile information comprises at least one of a name of the user, contact details of the user, details of a primary site of the user and information related to a working domain of the user.

12. The desktop provisioning system (107) as claimed in claim 10, wherein to identify the user the processor (203) is configured to:
receive one or more user login credentials from an access control unit (105) in the remote site; and
compare the one or more user login credentials information with information stored in a user details repository (109) associated with the desktop provisioning system (107).

13. The desktop provisioning system (107) as claimed in claim 10, wherein the one or more primary contextual data parameters (211) comprises at least one of configuration details of the primary desktop (101) and information related to one or more user specific applications configured in the primary desktop (101).

14. The desktop provisioning system (107) as claimed in claim 10, wherein the processor (203) provisions one of the one or more secondary desktops (113) as the personalized desktop if one or more contextual data parameters related to the one of the one or more secondary desktops (113) is similar to the one or more primary contextual data parameters (211).

15. The desktop provisioning system (107) as claimed in claim 10, wherein the processor (203) communicates one or more provisioning data (213) to the user through one or more user devices associated with the user to provision the personalized desktop to the user.

16. The desktop provisioning system (107) as claimed in claim 15, wherein the one or more provisioning data (213) comprises at least one of configuration details of the personalized desktop and location details of the personalized desktop.

17. The desktop provisioning system (107) as claimed in claim 10, wherein the processor (203) terminates a user session on the personalized desktop upon determining one of an idle condition of the personalized desktop for a predetermined threshold period and a user session log-off request from the user.

18. The desktop provisioning system (107) as claimed in claim 17, wherein the processor (203) updates the one or more primary contextual data parameters (211) upon termination of the user session based on one or more activities performed by the user on the personalized desktop during the user session.

19. A non-transitory computer readable medium including instructions stored thereon that when processed by a desktop provisioning system (107) performs operations comprising:
identifying the user in the remote site based on profile information of the user, wherein the remote site comprises one or more secondary desktops (113);
collecting one or more primary contextual data parameters (211) related to a primary desktop (101) associated with the user; and
provisioning one of the one or more secondary desktops (113) in the remote site as the personalized desktop for the user based on the one or more primary contextual data parameters (211).
